(19) United States
(12) Patent Application Publication
(10) Pub. No.: US 2026/0187771 A1
(43) Pub. Date: Jul. 2, 2026

(54) SOLVING LABEL ERRORS RELATED TO ELECTRON BEAM DEFECT IMAGES

(71) Applicant: Applied Materials Israel Ltd., Rehovot (IL)

(72) Inventors: Nadav Potasman, Rehovot (IL); Asaf Nisani, Rehovot (IL); Hila Kohane, Rehovot (IL); Boris Sherman, Rehovot (IL)

(73) Assignee: Applied Materials Israel Ltd., Rehovot (IL)

(21) Appl. No.: 19/002,594

(22) Filed: Dec. 26, 2024

(51) Int. Cl. G06T 7/00; G06V 10/764

(52) U.S. Cl. CPC G06T 7/0002; G06V 10/764; G06T 2207/10056; G06T 2207/20081

(57) ABSTRACT

An electron beam defect classification system, that includes (a) an imager that is configured to generate an electron beam image of a region of a sample by illuminating the region with an electron beam; and (b) a processing circuit configured to process the electron beam image to provide a defect classification result. The processing circuit includes an artificial intelligence processor that is configured to apply artificial intelligence processing on the electron beam image to provide the defect classification result. The artificial intelligence processing represented an artificial intelligence process that exhibits an accuracy that is contributed to a training of the artificial intelligence process using a dataset that has undergone a label error reduction process.

### BACKGROUND OF THE INVENTION

A defect review scanning electron microscope may use a neural network for defect classification.

The neural network is trained using a dataset that is manually labeled.

Due to the complexity associated with manually analyzing and then labeling electron beam defect images, it has been found that the manual labeling is inaccurate and that training the neural network using the manually labeled dataset will provide a trained neural network that once used for classification—will result in many classification errors.

There is a growing need to provide a cleaned dataset, a training method that will provide an accurate trained neural network, and an accurate defect classification method.

### BRIEF SUMMARY OF THE INVENTION

There is provided a method, a non-transitory computer readable medium and a system as illustrated in the application.

According to an embodiment there is provided a method that includes:
generating an electron beam image of a region of the sample, the region comprises structural elements having at least one microscopic dimension; wherein the generating of the electron beam image comprises illuminating the region with an electron beam; and
processing the electron beam image to provide a defect classification result, wherein the processing of the electron beam image comprises applying an artificial intelligence process on the electron beam image to provide the defect classification result.

According to an embodiment, the artificial intelligence processing represents an artificial intelligence process that exhibits an accuracy that is contributed to a training of the artificial intelligence process using a dataset that has undergone a label error reduction process that included:
Obtaining defect class type information indicative of different types of defect classes, wherein the electron beam defect images represent defects of the different types of defect classes.
Obtaining a dataset of labeled electron beam defect images.
Virtually partitioning the dataset to multiple dataset portions.
Repeating, for each dataset portion of the multiple dataset portions:
   i. Allocating the dataset portion to be a testing dataset portion.
   ii. Allocating other dataset portions of the multiple dataset portions to be training dataset portions.
   iii. Training an artificial intelligence process, by applying a supervised training process using the training dataset portions to provide a trained artificial intelligence process.
   iv. Testing the trained artificial intelligence process by feeding to the trained artificial intelligence process a label-less version of the testing dataset portion to determine a label based classification confidence level per electron beam defect image of the testing dataset.
   v. Determining, per each defect class, based on label based classification confidence levels associated with the defect class and a detect class type, a defect class type label rejection rule, wherein different detect class types are associated with different defect class type label rejection rules.
   vi. Selectively rejecting labels of the dataset of the labeled electron beam defect images, by applying the defect class type label rejection rules.

According to an embodiment there is provided an electron beam defect classification system, the electron beam defect classification system includes:
An imager that is configured to generate an electron beam image of a region of a sample, the region comprises structural elements having at least one microscopic dimension; wherein the imager comprises electron beam optics configured to illuminate the region with an electron beam.
A processing circuit configured to process the electron beam image to provide a defect classification result, wherein the processing circuit comprises an artificial intelligence processor that is configured to apply artificial intelligence processing on the electron beam image to provide the defect classification result.

According to an embodiment, the artificial intelligence processing represents an artificial intelligence process that exhibits an accuracy that is contributed to a training of the artificial intelligence process using a dataset that has undergone a label error reduction process that included:
Obtaining defect class type information indicative of different types of defect classes, wherein the electron beam defect images represent defects of the different types of defect classes.
Obtaining a dataset of labeled electron beam defect images.
Virtually partitioning the dataset to multiple dataset portions.
Repeating, for each dataset portion of the multiple dataset portions:
   i. Allocating the dataset portion to be a testing dataset portion.
   ii. Allocating other dataset portions of the multiple dataset portions to be training dataset portions.
   iii. Training an artificial intelligence process, by applying a supervised training process using the training dataset portions to provide a trained artificial intelligence process.
   iv. Testing the trained artificial intelligence process by feeding to the trained artificial intelligence process a label-less version of the testing dataset portion to determine a label based classification confidence level per electron beam defect image of the testing dataset.
   v. Determining, per each defect class, based on label based classification confidence levels associated with the defect class and a detect class type, a defect class type label rejection rule, wherein different detect class types are associated with different defect class type label rejection rules.
   vi. Selectively rejecting labels of the dataset of the labeled electron beam defect images, by applying the defect class type label rejection rules.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a system;

FIG. 2 illustrates an example of an electron beam defect classification system;

FIG. 3 illustrates an example of a method;

FIG. 4 illustrates an example of a step of the method of FIG. 3;

FIG. 5 illustrates an example of a method;

FIG. 6 illustrates examples of information and metadata; and

FIG. 7 illustrates examples of information and metadata.

### DETAILED DESCRIPTION OF THE INVENTION

The different figures illustrates examples of units and/or software and/or information items and/or steps and/or components. These examples are provided for brevity of explanation. At least one of the units and/or software and/or information items and/or steps and/or components is optional or mandatory.

Artificial intelligence is used to classify machines that mimic human intelligence and human cognitive functions like learning and problem solving. There are three types of artificial intelligence that include artificial super intelligence, artificial narrow intelligence, and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

The term “cleaned dataset” (also referred to as “clean dataset of labeled electron beam defect images”) is a dataset that undergone a cleaning process that includes selectively rejecting labeled electron beam defect images—such as the cleaning process implemented by method 300.

The term “accurate artificial intelligence process” is an artificial intelligence process that was trained using the cleaned dataset, and is more accurate than (exhibits an enhanced accuracy in comparison to) the same artificial intelligence process that was trained using the dataset of labeled electron beam defect images, before being cleaned.

According to an embodiment, there is provided a method, a non-transitory computer readable medium, a computerized system and/or an electron beam defect classification system for at least one of:
Automatically providing a cleaned dataset of electron beam defect images.
Automatically training an accurate artificial intelligence process using the clean dataset.
Utilizing an accurate artificial intelligence process for providing an accurate defect classification.

According to an embodiment, a dataset of labeled electron beam defect images that were manually labeled undergoes a cleaning process to obtain indications about the classification confidence levels associated with different types of classes, and the classification confidence levels associated with different types of classes are processed to determine defect class type label rejection rules. The defect class type label rejection rules are applied on the dataset of labeled electron beam defect images to provide a clean dataset of labeled electron beam defect images.

According to an embodiment, the clean dataset of labeled electron beam defect images is used during training of an accurate machine learning process.

According to an embodiment, the accurate artificial intelligence process is used during inference to perform defect classification based on electron beam defect images. The inference includes artificial intelligence processing that represents the accurate artificial intelligence process—in the sense that the processing applies (or executes) the accurate artificial intelligence process.

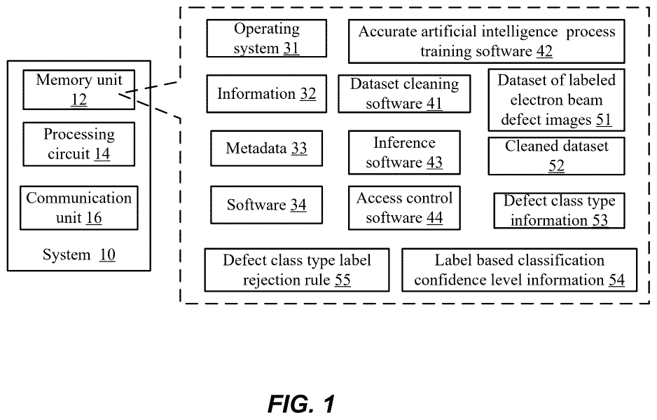

FIG. 1 illustrates an example of a system 10 which is a computerized system, for cleaning a dataset of labeled electron beam defect images.

According to an embodiment, system 10 includes a memory unit 12, a processing circuit 14 and a communication unit 16.

According to an embodiment, the processing circuit 14 is implemented as a central processing unit (CPU), and/or as one or more other integrated circuits such as application specific integrated circuits (ASICs), field programmable gate arrays (FPGAs), full-custom integrated circuits, graphic processing units (GPUs), and the like.

According to an embodiment, memory unit 12 is any type of hardware memory unit—a volatile memory unit, a non-volatile unit, a random access memory unit, a dynamic random access memory unit, one or more disks, one or more solid stage drives (SSDs), a memristor based memory unit, a magnetic memory unit, a flash memory unit, and the like.

According to an embodiment, system 10 is server, a laptop, a desktop, and the like.

According to an embodiment, memory unit 12 stores concurrently the entire dataset of labeled electron beam defect images.

According to an embodiment, memory unit 12 stores only up to a portion of the entire dataset of labeled electron beam defect images at any given point of time-and may be dynamically fed by the portions required for processing.

According to an embodiment, memory unit 12 is configured to store firmware and/or software, one or more operating systems, data and metadata required to the execution of any of the methods mentioned in this application.

FIG. 1 illustrates memory unit 12 as storing at least one of operating system 31, information 32, metadata 33, and software 34.

Examples of software 34 include at least one of dataset cleaning software 41 (for executing at least steps 330 and 340 of method 300), accurate artificial intelligence process training software 42 (for executing step 350), inference software 43 (for using the accurate artificial intelligence process during the evaluation of a sample for executing step 430), and access control software 44 for controlling access to at least the dataset of labeled electron beam defect images and/or controlling access to the cleaned dataset and/or for controlling access to any content of memory unit 12.

Examples of information 32 and/or metadata 33 include at least one of dataset of labeled electron beam defect images 51, cleaned dataset 52, defect class type information 53, label based classification confidence level information 54, and defect class type label rejection rule 55.

According to an embodiment, the dataset of labeled electron beam defect images and/or the cleaned dataset are access protected and only entities that are entitled to access them are provided access. According to an embodiment, the creation of the cleaned dataset triggers a sending of a message to the entitled entities.

According to an embodiment, system 10 is configured to execute method 300 for solving label errors related to electron beam defect images.

According to an embodiment, system 10 is configured to:
Obtain defect class type information indicative of different types of defect classes.
Obtain a dataset of labeled electron beam defect images. The electron beam defect images represent defects of the different types of defect classes.
Perform multiple training iterations of a machine learning process so that each electron beam defect image of the dataset is used for testing in one of the training iteration and is used as training image at other training iterations. The outcome is a label based classification confidence level per each of the electron beam defect images when used for testing.
Determine, per each defect class, based on label based classification confidence levels associated with the defect class and a detect class type, a defect class type label rejection rule.
Selectively reject labels of the dataset of the labeled electron beam defect images, by applying the defect class type label rejection rules—to provide a cleaned dataset.

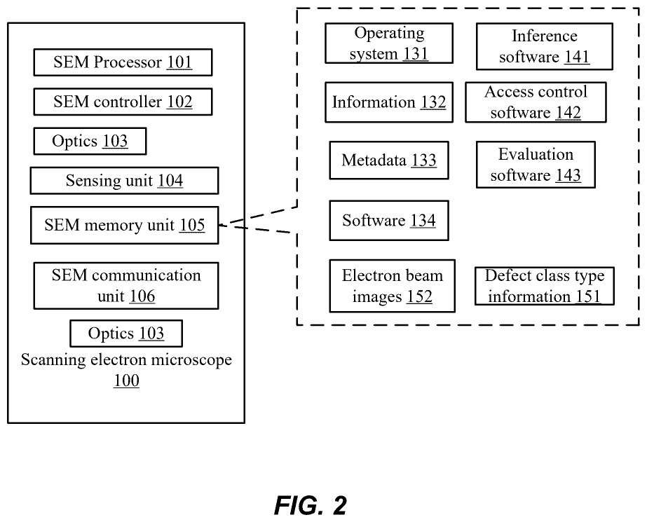

FIG. 2 illustrates an example of an electron beam defect classification system 100. For simplicity of explanation, it is assumed that the electron beam defect classification system is a scanning electron microscope (SEM). Any reference to a SEM should be applied, mutatis mutandis to any other electron beam defect classification system.

According to an embodiment, the electron beam defect classification system 100 includes (a) a SEM processor 101 that may have image processing capabilities and includes one or more processing circuits, (b) a SEM controller 102 for controlling the electron beam defect classification system, (c) optics 103 that is configured to scan the tiles of the sample with an electron beam, (d) a sensing unit 104 that is configured to detect particles emitted due to the scan and generate detection signals indicative of the structural elements within the tiles of the sample, (e) a SEM memory unit 105 and (f) a SEM communication unit 106.

According to an embodiment, the electron beam defect classification system is a scanning electron microscope (SEM). An example of a scanning electron microscope is the SEMVISION™ of APPLIED MATERIALS™ Inc. of San Jose, California.

According to an embodiment, the electron beam defect classification system uses an electron beam that illuminates a sample, including defects of the sample, having electrons or other particles from the sample reach sensing unit 104.

According to an embodiment, the electron beam defect classification system includes a column, a vacuum chamber in which the sample is located, a mechanical stage for supporting the sample and for moving the sample.

According to an embodiment, the sensing unit 104 includes one or more detectors such as one or more secondary electron detectors, one or more backscattered electron detectors, and the like. Detectors for detecting photons and additionally or alternatively x-rays may also be included in the charged particle evaluation system. Examples of a column that includes multiple sensors are illustrated in U.S. Pat. No. 7,847,267 of Shemesh et al. which is incorporated herein by reference. Any detector of the electron beam defect classification system may be located within the column or outside the column. A detector may include a single sensing segment, may include multiple sensing segments, maybe a part of an array of sensors, and the like.

According to an embodiment, optics 103 includes an electron beam source and electron beam manipulation optics that is configured to propagate an electron beam through the column till exiting the column. The electron beam manipulation optics may include deflection lenses, focusing lenses, electron beam collimating optics, electron beam shaping optics, and the like. Examples of optics arranges in a column that includes multiple deflection coils for double-deflecting an electron beam are illustrated in U.S. Pat. No. 7,847,267 of Shemesh et al. which is incorporated herein by reference.

According to an embodiment, the electron beam manipulation optics include bypass magnetic scan coils that are configured to direct the electron beam along a bypass path, objective lens that is configured to focus the electron beam on the sample, and deflector lenses for deflecting the electron beam according to a scan pattern.

According to an embodiment, the electron beam defect classification system includes a vacuum system configured to maintain the column in vacuum, and a high power supply unit configured to provide high voltage signals to accelerate the electron beam and to decelerate the electron beam.

According to an embodiment, the electron beam defect classification system is not involved in the cleaning of the dataset and is not involved in the training of the accurate machine learning process, SEM memory unit 105 stores inference software 43 and does not store the dataset cleaning software or the accurate artificial intelligence process training software.

According to an embodiment, SEM memory unit 105 stores at least one of operating system 131, information 132, metadata 133, and software 134.

Examples of software 134 include inference software 141 (for using the accurate artificial intelligence process during the evaluation of a sample, the inference software may include an accurate artificial intelligence process software), access control software 142, and evaluation software 143 for evaluating the sample—for example for performing defect detection and/or defect review and/or for controlling the operation of the SEM, and the like).

Examples of information and/or metadata include at least one of defect class type information 151, electron beam images 152 acquired by the SEM that includes electron beam defect images, suspected defect information indicative of suspected defects to be reviewed, and the like.

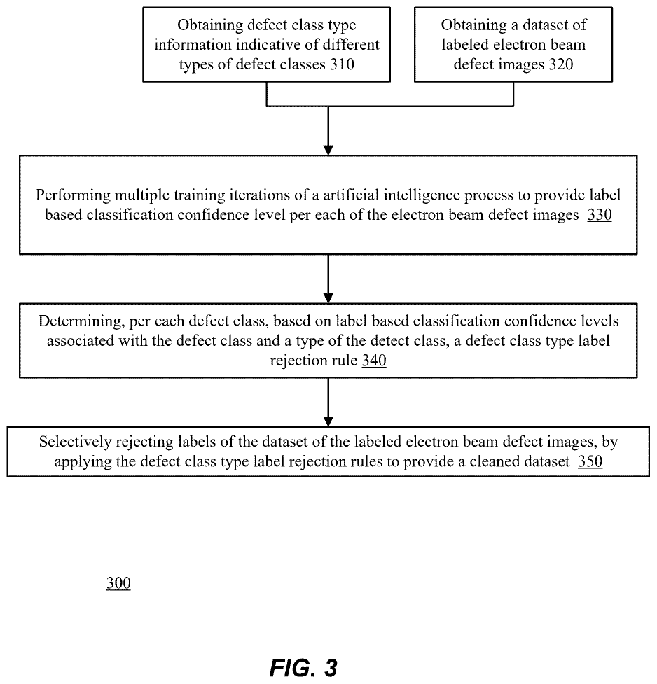

FIG. 3 illustrates an example of method 300 for solving label errors related to electron beam defect images.

According to an embodiment, method 300 starts with steps 310 and 320.

According to embodiment, step 310 includes obtaining defect class type information indicative of different types of defect classes.

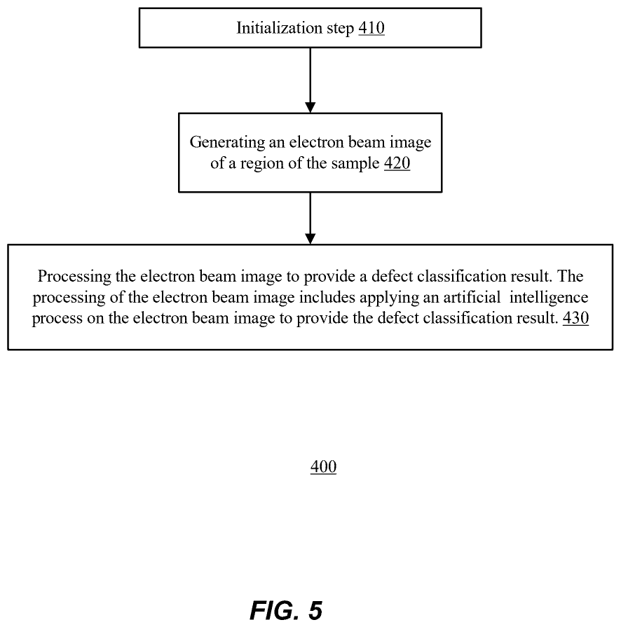

According to embodiment, step 320 includes obtaining a dataset of labeled electron beam defect images. The electron beam defect images represent defects of the different types of defect classes. FIG. 5 illustrates an example of an example of a dataset of labeled electron beam defect images 51.

According to an embodiment, steps 310 and 320 are followed by step 330 of performing multiple training iterations of a machine learning process so that each electron beam defect image of the dataset is used for testing in one of the training iteration and is used as training image at other training iterations.

The outcome of step 330 is a label based classification confidence level per each of the electron beam defect images when used for testing. The machine learning process is reset between one training iteration to the other. Alternatively, different instances of the machine learning process are used in different training iterations.

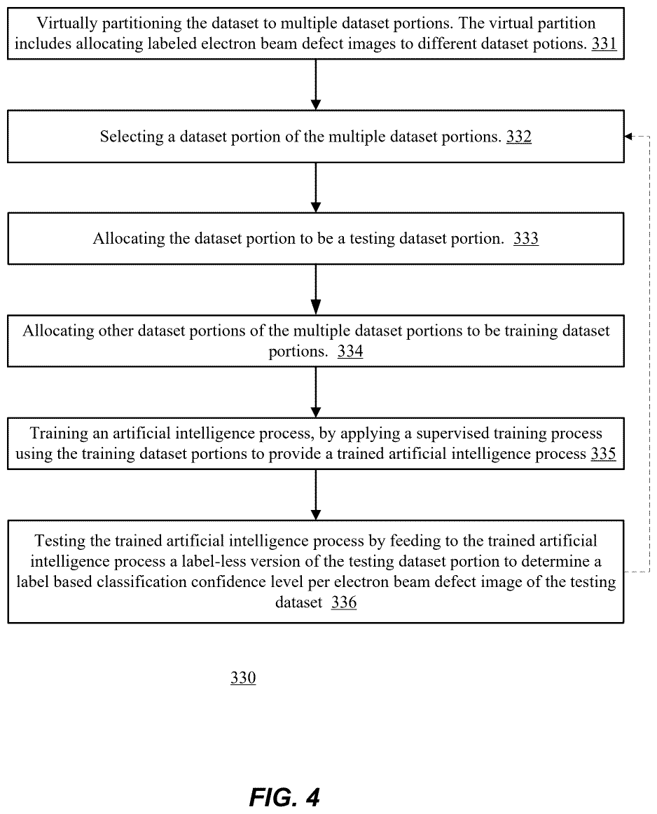

According to an embodiment, step 330 includes (see FIG. 4):
Step 331 of virtually partitioning the dataset to multiple dataset portions. The virtual partition includes allocating labeled electron beam defect images to different dataset potions.
Step 332 of selecting a dataset portion of the multiple dataset portions.
Step 333 of allocating the dataset portion to be a testing dataset portion.
Step 334 of allocating other dataset portions of the multiple dataset portions to be training dataset portions.
Step 335 of training an artificial intelligence process, by applying a supervised training process using the training dataset portions to provide a trained artificial intelligence process.
Step 336 of testing the trained artificial intelligence process by feeding to the trained artificial intelligence process a label-less version of the testing dataset portion to determine a label based classification confidence level per electron beam defect image of the testing dataset. The feeding involves feeding the electron beam defect images without their associated labels to the trained artificial intelligence process. The trained artificial intelligence process is configured to process an electron beam defect image to provide a set of confidence levels associated with different classes of defects. A label associated with the electron beam defect image is used to select the confidence level associated with the defect that is defined by the label.
Jumping to step 332 for selecting a new dataset portion and repeating steps 332-336 until all dataset portions are selected.

According to an embodiment, step 330 is followed by step 340 of determining, per each defect class, based on label based classification confidence levels associated with the defect class and a detect class type, a defect class type label rejection rule. According to an embodiment, different defect class types are associated with different defect class type label rejection rules.

According to an embodiment, the different types of defect classes are associated with different detection parameters, for example, different tradeoffs between the different detection parameters. Detection parameters may include at least one of a false positive parameter (such as rate or absolute number), a false negative parameter (such as rate or absolute number), a true positive parameter (such as rate or absolute number), a true negative parameter (such as rate or absolute number), detection sensitivity, detection robustness, and the like.

According to an embodiment, the different types of defect classes are associated with different levels of interest. According to an embodiment, a higher sensitivity is allocated to defects of higher levels of interest.

According to an embodiment, the different types of defect classes are associated with different levels of defect criticality. According to an embodiment, a higher sensitivity is allocated to defects of higher defect criticality.

According to an embodiment, the different types of defect classes include at least two types out of (a) non-visual defect, (b) defect of interest, or (c) key defect of interest.

According to an embodiment, the defect class type label rejection rule defines a manner of determining a minimal classification confidence level threshold of the defect class type.

According to an embodiment different defect class types are associated with different manners for determining minimal classification confidence level thresholds - for example, the different manners may differ by defining higher minimal classification confidence level thresholds to defect class types of less interest. Examples for introducing the difference in the definition of the minimal classification confidence level threshold includes defining the minimal classification confidence level thresholds based on different percentiles of classification confidence level values, defining the minimal classification confidence level thresholds based on different margins from a value generated by statistically processing the classification confidence level thresholds related to defects of different defect class types, and the like.

According to an embodiment, step 340 is followed by step 350 of selectively rejecting labels of the dataset of the labeled electron beam defect images, by applying the defect class type label rejection rules. The outcome of step 340 is a cleaned dataset.

According to an embodiment, step 350 of training an artificial intelligence process for use in inference, by using the cleaned dataset to provide an accurate artificial intelligence process.

According to an embodiment, the artificial intelligence process for use in inference is identical to the artificial intelligence process trained and tested during step 330. According to an embodiment, the artificial intelligence process for use inference differs from the artificial intelligence process trained and tested during step 330.

According to an embodiment defects include misalignment, foreign particles, scratches, deviations from design, deviation of manufactured features from expected or allowed shape and/or size and/or spatial relationship with other features, and the like.

FIG. 5 illustrates an example of method 400 for evaluating a sample.

According to an embodiment, method 400 starts with initialization step 410.

According to an embodiment the initialization step 410 includes executing at least one step of method 300.

According to an embodiment the initialization step 410 includes training the accurate artificial intelligence process. According to an embodiment, a separate method is allocated for training the accurate artificial intelligence process.

According to an embodiment, initialization step 410 includes receiving the accurate artificial intelligence process.

According to an embodiment, initialization step 410 includes receiving a memory unit that stores at least some of the content of SEM memory unit 105 of FIG. 2 or storing in the memory unit at least some of the content of SEM memory unit 105 of FIG. 2.

According to an embodiment, initialization step 410 is followed by step 420 of generating an electron beam image of a region of the sample. The region includes structural elements having at least one microscopic dimension. The generating of the electron beam image includes illuminating the region with an electron beam. A microscopic dimension is a dimension that may be smaller than 50, 20, 10, 0.1, 0.01, 0.001 micron, and the like.

According to an embodiment, step 420 is followed by step 430 of processing the electron beam image to provide a defect classification result. The processing of the electron beam image includes applying an artificial intelligence process on the electron beam image to provide the defect classification result.

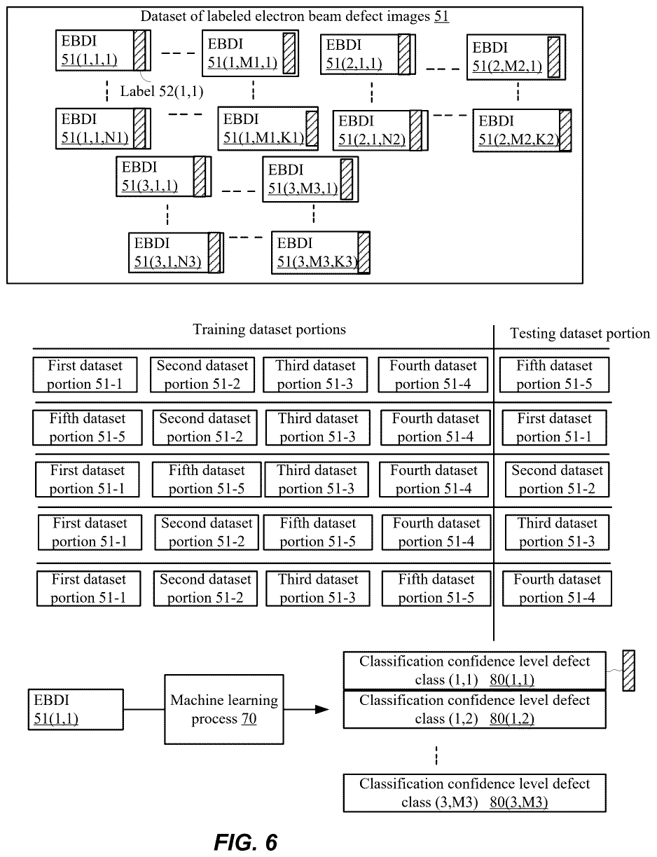

FIG. 6 illustrates an example of a dataset of labeled electron beam defect images 51. In FIG. 6 there are three defect class types, but any number of defect type classes may exist.

The dataset of labeled electron beam defect images 51 includes labeled electron beam defect images (EBDIs) of three defect class types, the first defect class type includes a first plurality (M1) of defect classes, the second defect class type includes a second plurality (M2) of defect classes, and the third defect class type includes a third plurality (M3) of defect classes.

Each EBDI is associated with reference number with three indices—the leftmost index is indicative of the defect class type, the middle index is associated with an order of the defect class within the defect class type, and the rightmost index is indicative of the EBID itself.

Regarding the first defect class type—there are N1 EDBIs associated with defect class (1,1)—see EDBIs 51(1,1,1)-51(1,1,N1). There are K1 EDBIs associated with defect class (1,M1)—see EDBIs 51(1,M1,1)-51(1,M1,K1).

Regarding the second defect class type—there are N2 EDBIs associated with defect class (2,1)—see EDBIs 51(2,1,1)-51(2,1,N2). There are K2 EDBIs associated with defect class (1,M2)—see EDBIs 51(2,M2,1)-51(2,M2,K2).

Regarding the third defect class type—there are N3 EDBIs associated with defect class (3,1)—see EDBIs 51(3,1,1)-51(3,1,N3). There are K3 EDBIs associated with defect class (1,M3)—see EDBIs 51(3,M3,1)-51(3,M3,K3).

Each EDBI also includes a label—which is manually determined as is indicative of the defect class of the defect captured by the EDBI.

FIG. 6 also illustrates the virtual partition of the dataset of labeled electron beam defect images 51 to file dataset portions, including a first dataset portion 51-1, a second dataset portion 51-2, a third dataset portion 51-3, a fourth dataset portion 51-4, and a fifth dataset portion 51-5. The virtual partition may be executed in any manner.

During five iteration different dataset portions are selected to be a testing dataset portion nd training dataset portions, respectively.

FIG. 6 also illustrates that EDBI 51(1,1) (labeled as capturing a defect of defect class (1,1)) is being fed, without its label to an artificial intelligence process 70 that outputs, per EDBI 51(1,1) a classification confidence level regarding the content of EDBI(1,1) per each defect class out of defect class (1,1) till defect class (3,M3)—see classification confidence level defect class (1,1)—classification confidence level defect class (3,M3)—80(1,1)—80(3,M3).

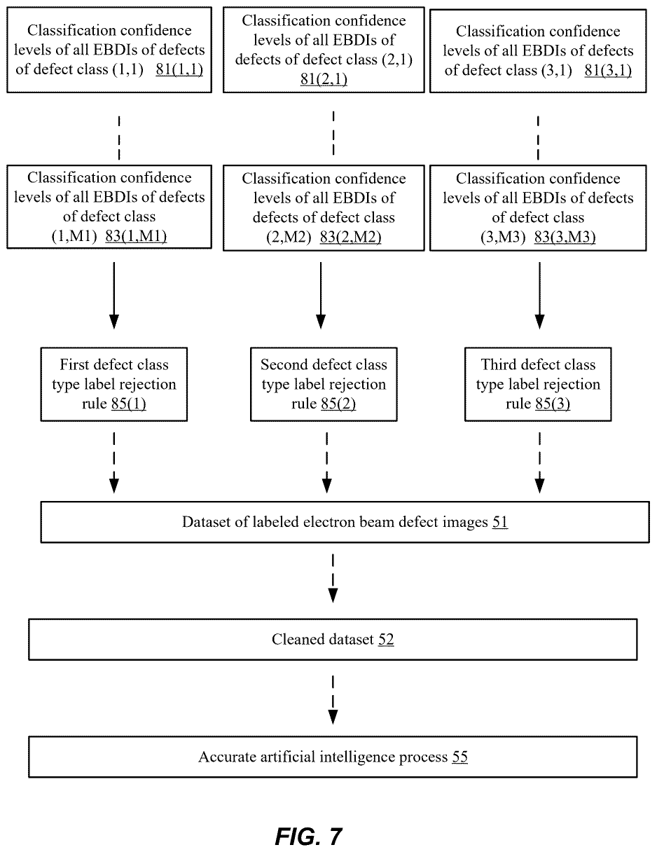

FIG. 7 illustrates examples of the outcome of the training iterations—classification confidence levels per all EDBIs of each defect class.

In relation to the first defect class type, including defect classes (1,1) till (1,M1)—see
For defect class (1,1)—classification confidence levels of all EBDIs of defects of defect class (1,1) 81(1,1).
For defect class (1,M1)—classification confidence levels of all EBDIs of defects of defect class (1,M1) 81(1,M1).

In relation to the second defect class type—including defect classes (2,1) till (2,M2) - see
For defect class (2,1)—classification confidence levels of all EBDIs of defects of defect class (2,1) 81(2,1).
For defect class (2,M2)—classification confidence levels of all EBDIs of defects of defect class (2,M2) 81(2,M2).

In relation to the third defect class type, including defect classes (3,1) till (3,M3), see
For defect class (3,1)—classification confidence levels of all EBDIs of defects of defect class (3,1) 81(3,1).
For defect class (3,M3)—classification confidence levels of all EBDIs of defects of defect class (3,M3) 81(3,M3).

The classification levels related to the first defect class type are processed to provide first defect class type label rejection rule 85(1). The classification levels related to the second defect class type are processed to provide second defect class type label rejection rule 85(2). The classification levels related to the third defect class type are processed to provide third defect class type label rejection rule 85(3).

The first defect class type label rejection rule 85(1), the second defect class type label rejection rule 85(2), and the third defect class type label rejection rule 85(3) are applied on the dataset of labeled electron beam defect images (each image of a certain defect class type is processed with the corresponding defect class type label rejection rule to provide the cleaned dataset.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements, or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

What is claimed is:

1. An electron beam defect classification system, the electron beam defect classification system comprising:
an imager configured to generate an electron beam image of a region of a sample, the region comprising structural elements having at least one microscopic dimension, wherein the imager comprises electron beam optics configured to illuminate the region with an electron beam; and
a processing circuit configured to process the electron beam image to provide a defect classification result, wherein the processing circuit comprises an artificial intelligence processor configured to apply artificial intelligence processing on the electron beam image to provide the defect classification result;
wherein the artificial intelligence processing represents an artificial intelligence process that exhibits an accuracy that is contributed to a training of the artificial intelligence process using a dataset that has undergone a label error reduction process that comprises:
obtaining defect class type information indicative of different types of defect classes, wherein the electron beam defect images represent defects of the different types of defect classes;
obtaining a dataset of labeled electron beam defect images;
virtually partitioning the dataset to multiple dataset portions;
repeating, for each dataset portion of the multiple dataset portions:
allocating the dataset portion to be a testing dataset portion;
allocating other dataset portions of the multiple dataset portions to be training dataset portions;
training an artificial intelligence process, by applying a supervised training process using the training dataset portions to provide a trained artificial intelligence process; and
testing the trained artificial intelligence process by feeding to the trained artificial intelligence process a label-less version of the testing dataset portion to determine a label based classification confidence level per electron beam defect image of the testing dataset;
determining, per each defect class, based on label based classification confidence levels associated with the defect class and a detect class type, a defect class type label rejection rule; wherein different detect class types are associated with different defect class type label rejection rules; and
selectively rejecting labels of the dataset of the labeled electron beam defect images, by applying the defect class type label rejection rules.

2. The electron beam defect classification system according to claim 1, further comprising a training circuit configured to perform the training of the artificial intelligence process.

3. The electron beam defect classification system according to claim 1, further comprising a label error reduction circuit that is configured to perform the label error reduction process.

4. The electron beam defect classification system according to claim 1, wherein the different types of defect classes are associated with different levels of interest.

5. The electron beam defect classification system according to claim 1, wherein the different types of defect classes are associated with different levels of defect criticality.

6. The electron beam defect classification system according to claim 1, wherein the different types of defect classes comprise at least two types out of (a) non-visual defect, (b) defect of interest, or (c) key defect of interest.

7. The electron beam defect classification system according to claim 1, wherein the defect class type label rejection rule defines a manner of determining a minimal classification confidence level threshold of the defect class type.

8. A method for evaluating a sample, the method comprising:
generating an electron beam image of a region of the sample, the region comprising structural elements having at least one microscopic dimension, wherein the generating of the electron beam image comprises illuminating the region with an electron beam; and
processing the electron beam image to provide a defect classification result, wherein the processing of the electron beam image comprises applying an artificial intelligence process on the electron beam image to provide the defect classification result;
wherein the artificial intelligence process exhibits an accuracy that is contributed to a training of the artificial intelligence process using a dataset that has undergone a label error reduction process that comprises:
obtaining defect class type information indicative of different types of defect classes, wherein the electron beam defect images represent defects of the different types of defect classes;
obtaining a dataset of labeled electron beam defect images;
virtually partitioning the dataset to multiple dataset portions;
repeating, for each dataset portion of the multiple dataset portions:
allocating the dataset portion to be a testing dataset portion;
allocating other dataset portions of the multiple dataset portions to be training dataset portions;
training an artificial intelligence process, by applying a supervised training process using the training dataset portions to provide a trained artificial intelligence process; and
testing the trained artificial intelligence process by feeding to the trained artificial intelligence process a label-less version of the testing dataset portion to determine a label based classification confidence level per electron beam defect image of the testing dataset;
determining, per each defect class, based on label based classification confidence levels associated with the defect class and a detect class type, a defect class type label rejection rule; wherein different detect class types are associated with different defect class type label rejection rules; and
selectively rejecting labels of the dataset of the labeled electron beam defect images, by applying the defect class type label rejection rules.

9. The method according to claim 8, further comprising performing the training of an artificial intelligence process.

10. The method according to claim 8, further comprising performing the label error reduction process.

11. The method according to claim 8, wherein the different types of defect classes are associated with different levels of interest.

12. The method according to claim 8, wherein the different types of defect classes are associated with different levels of defect criticality.

13. The method according to claim 8, wherein the different types of defect classes comprise at least two types out of (a) non-visual defect, (b) defect of interest, or (c) key defect of interest.

14. The method according to claim 8, wherein the defect class type label rejection rule defines a manner of determining a minimal classification confidence level threshold of the defect class type.

15. A non-transitory computer readable medium for evaluating a sample, the non-transitory computer readable medium stores instructions executed by an electron beam defect classification system for:
generating an electron beam image of a region of the sample, the region comprises structural elements having at least one microscopic dimension, wherein the generating of the electron beam image comprises illuminating the region with an electron beam; and
processing the electron beam image to provide a defect classification result, wherein the processing of the electron beam image comprises applying an artificial intelligence process on the electron beam image to provide the defect classification result;
wherein the artificial intelligence process exhibits an accuracy that is contributed to a training of the artificial intelligence process using a dataset that has undergone a label error reduction process that comprises:
obtaining defect class type information indicative of different types of defect classes, wherein the electron beam defect images represent defects of the different types of defect classes;
obtaining a dataset of labeled electron beam defect images;
virtually partitioning the dataset to multiple dataset portions;
repeating, for each dataset portion of the multiple dataset portions:
allocating the dataset portion to be a testing dataset portion;
allocating other dataset portions of the multiple dataset portions to be training dataset portions;
training an artificial intelligence process, by applying a supervised training process using the training dataset portions to provide a trained artificial intelligence process; and
testing the trained artificial intelligence process by feeding to the trained artificial intelligence process a label-less version of the testing dataset portion to determine a label based classification confidence level per electron beam defect image of the testing dataset;
determining, per each defect class, based on label based classification confidence levels associated with the defect class and a detect class type, a defect class type label rejection rule; wherein different detect class types are associated with different defect class type label rejection rules; and
selectively rejecting labels of the dataset of the labeled electron beam defect images, by applying the defect class type label rejection rules.
